(19) United States
(12) Patent Application Publication
(10) Pub. No.: US 2013/0181809 A1
(43) Pub. Date: Jul. 18, 2013

(54) SpaceCube MINI

(71) Applicants: Michael R. Lin, Ellicott City, MD (US); David J. Petrick, SEVERNA PARK, MD (US); ALESSANDRO GElST, BETHESDA, MD (US); Thomas P. Flatley, Huntington, MD (US)

(72) Inventors: Michael R. Lin, Ellicott City, MD (US); David J. Petrick, SEVERNA PARK, MD (US); ALESSANDRO GElST, BETHESDA, MD (US); Thomas P. Flatley, Huntington, MD (US)

(21) Appl. No.: 13/551,649

(22) Filed: Jul. 18, 2012

Related U.S. Application Data
(60) Provisional application No. 61/512,252, filed on Jul. 27, 2011.

(51) Int. Cl. G05B 19/02

(52) U.S. Cl. CPC G05B 19/02
USPC 340/4.3

(57) ABSTRACT

An on-board space processing system capable of processing data at more than 2500 Million Instructions Per Second on board a spacecraft is disclosed. The system may be a cube, and may include processor card and a hybrid card. The processor card may include a processor that may be programmable and reprogrammable prior to, and during, spaceflight. The hybrid card may include a field programmable gate array module that may program and reprogram the processor prior to, and during, the spaceflight.

### CLAIM TO PRIORITY

This application claims priority to Provisional Application No. 61/512,252, titled “SpaceCube MINI,” filed on Jul. 27, 2011, the contents of which are herein incorporated by reference.

### ORIGIN OF INVENTION

The invention described herein was made by an employee of the United States Government, and may be manufactured and used by or for the Government for governmental purposes without the payment of any royalties thereon or therefor.

### FIELD

The present invention relates to a mini-cube and, more particularly, to a spaceflight mini-cube for on-board spacecraft processing.

### BACKGROUND

Processors currently used in a spacecraft may be large and consume sufficient amounts of precious space. Furthermore, the processors may not have sufficient computational power, having speeds up to 400 Million Instructions Per Second (MIPS) or 200 MHz. Thus, a smaller on-board processing unit that consumes a relatively small amount of space and has sufficient computational power for modern space missions may be beneficial.

### SUMMARY

Certain embodiments of the present invention may provide solutions to the problems and needs in the art that have not yet been fully identified, appreciated, or solved by current on-board space processing units. For example, embodiments of the present invention pertain to a space mini-cube that includes a processing card with memory, a power supply and high computing power for a radiation hardened space flight processor.

In one embodiment, a space processing apparatus includes a processor card and a hybrid card. The processor card includes a processor that can be programmed and reprogrammed prior to, and during, spaceflight. The hybrid card includes a field programmable gate array module that can program and reprogram the processor card prior to. and during, the spaceflight.

In another embodiment, an on-board space processing system includes a processor card and a hybrid card. The processor card includes a reprogrammable processor, and the hybrid card includes a field programmable gate array module configured to program the processor at initialization of the system and reprogram the processor during flight.

In yet another embodiment of the present invention, an apparatus includes a processor card operably coupled to a hybrid card via a first rigid flex connection. The apparatus also includes a power card operably coupled to the hybrid card via a second rigid flex connection. The processor card includes a reprogranunable processor that can process data at more than 2500 MIPS onboard a spacecraft.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should he understood that these drawings depict only typical embodiments of the invention and are not therefore to be considered to be limiting of its scope, the invention will be described and explained with additional specificity and detail through the use of the accompanying drawings, in which:

FIG. 1 illustrates a block diagram of a space mini-cube, according to an embodiment of the present invention.

FIG. 2 illustrates a processor card, according to an embodiment of the present invention.

FIG. 3 illustrates a hybrid card, according to an embodiment of the present invention.

FIG. 4 illustrates a power card, according to an embodiment of the present invention.

### DETAILED DESCRIPTION OF THE EMBODIMENTS

It will be readily understood that the components of the invention, as generally described and illustrated in the figures herein, may be arranged and designed in a wide variety of different configurations. Thus, the following detailed description of the embodiments is not intended to limit the scope of the invention as claimed, but is merely representative of selected embodiments of the invention.

The features, structures, or characteristics of the invention described throughout this specification may be combined in any suitable manner in one or more embodiments. For example, the usage of “certain embodiments,” “some embodiments,” or other similar language, throughout this specification refers to the fact that a particular feature, structure, or characteristic described in connection with an embodiment may be included in at least one embodiment of the invention. Thus, appearances of the phrases “in certain embodiments,” “in some embodiments,” “in other embodiments,” or other similar language, throughout this specification do not necessarily all refer to the same embodiment or group of embodiments, and the described features, structures, or characteristics may be combined in any suitable manner in one or more embodiments.

One or more embodiments of the present invention pertain to a space mini-cube that can be used as an on-board spaceflight processing system capable of more than 2500 MIPS. The mini-cube includes a processor card and a hybrid card. The processor card includes a processor that can be programmed and reprogrammed prior to, and during, spaceflight. The hybrid card includes a field programmable gate array module that can program and reprogram the processor prior to, and during, the spaceflight.

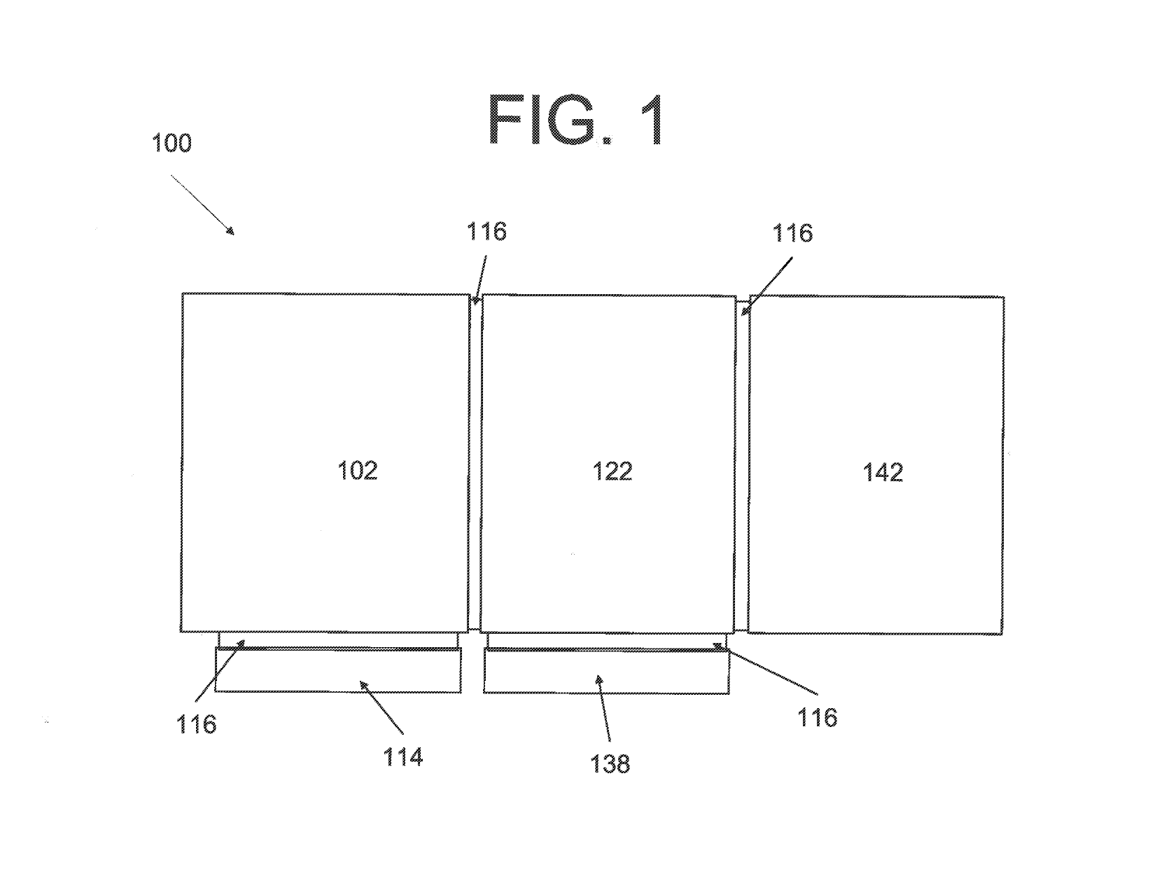

FIG. 1 illustrates a block diagram of a space mini-cube 100, according to an embodiment of the present invention. Space mini-cube 100 may be a full-fledged on-board space processing system capable of more than 2500 MIPS, and may feature a plurality of plug-and-play gigabit and standard interfaces in a condensed form factor of 3 inches by 3 inches by 3 inches in some embodiments. Space mini-cube 100 may consume less than 10 watts of power and weigh less than 3 pounds.

Space mini-cube 100 may include three primary components, e.g., a processor card 102, a hybrid card 122, and a power card 142. Processor card 102, hybrid card 122, and power card 142 are operably connected using a plurality of rigid flex connections 116 that allows the components of space mini-cube 100 to form into a cube. Each rigid flex connection 116 may be lightweight and provide high-speed data transmission. Processor card 102 may be connected to an input/output (I/O) connector 114 via rigid flex connection 116, and hybrid card 122 may also be connected to an I/O connector 138, via rigid flex connection 116.

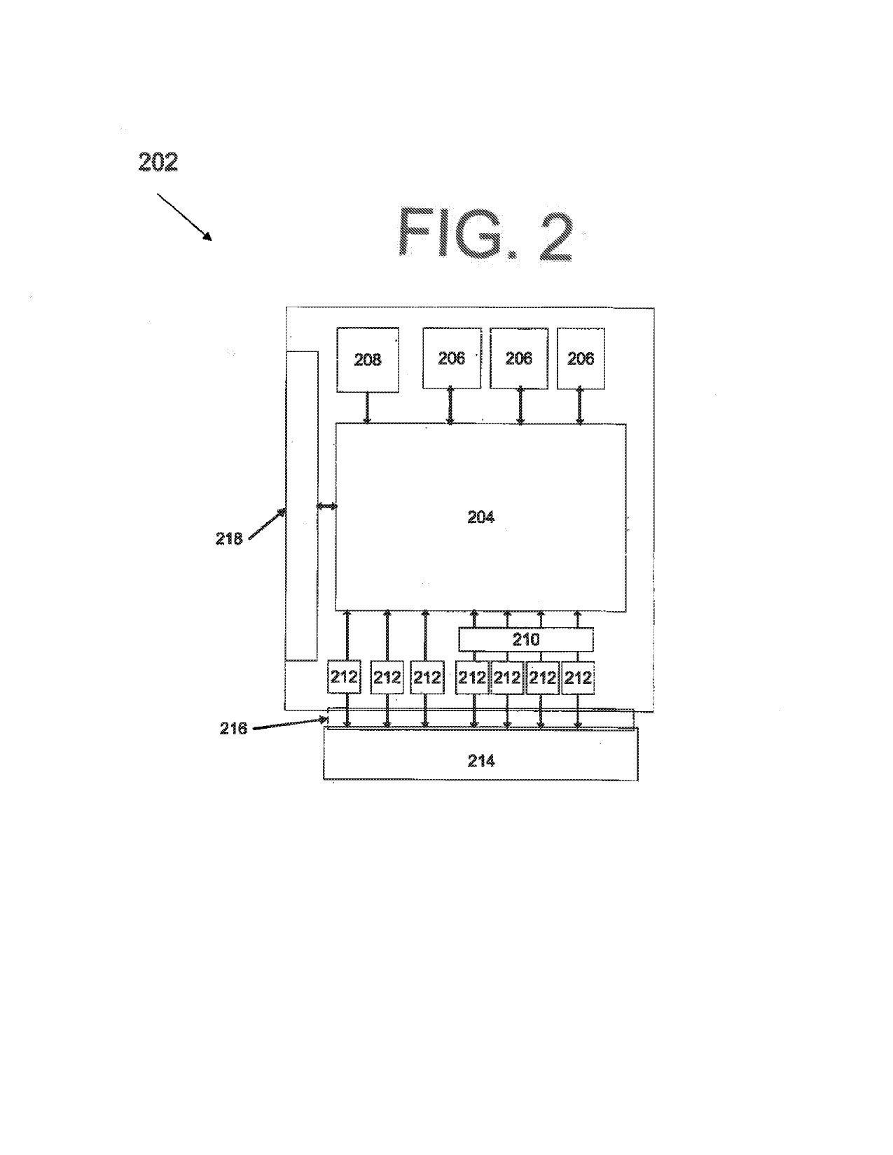

FIG. 2 illustrates a processor card 202, according to an embodiment of the present invention. Processor card 202 may include a processor 204. Processor 204 may be a Xilinx Virtex-5 FX130T commercial processor, Virtex-5QV radiation hardened field programmable gate array (FPGA) module, or any type of processor that would be appreciated by a person of ordinary skill in the art. Processor 204 may also be reprogrammable or reconfigurable for each flight mission, or in-flight, without changing components of the space mini-cube. For example, processor 204 may be electronically reprogrammed by changing the algorithm for each space mission or during space flight while on a mission. In certain embodiments, processor card 202 may include at least two processors, or any number of processors, depending on design choice. This allows the FPGA fabric to be changed, thus allowing the interfaces on the processor to be changed.

Processor card 202 may also include a plurality of memory devices 206, such as flash memory, for storage, and multi-gigabit transceiver (MGT) clock circuitry 208. Each of memory devices 206 may be used for non-volatile storage or volatile storage. For example, memory 206 may store one or more operating systems for processor 204 to execute, an initial data set, or any software that would be appreciated by a person of ordinary skill in the art. MGT clock circuit 208 is configured to provide a clean clock for MGT transceivers 210 such that the ports 212 of the MGT transceivers can have different clock speeds.

A plurality of ports 212 may be used to connect processor 204 to one or more scientific instruments (not shown). For example, this embodiment may include two serial advanced technology attachment (SATA) II ports, a Xilinx MGT port, and four space-wire (SpW) ports. The scientific instruments may be connected to an I/O connector 214. It should be appreciated that a rigid flex connection 216 connects processor card 202 with I/O connector 214. I/O connector 214 may be a J1 processor card I/O connector with 40 single ended lines and 7 differential gigabits. At least sonic of ports 212 may be operably coupled to processor 204 via low voltage differential signal (LYDS) transceivers 210. LVDS transceivers 210 may create a buffer to protect processor 204, or some of the plurality of ports 212, from being damaged by external sources.

Processor card 202 may include an expansion card I/O connector 218 that allows a custom card for a particular space mission to be connected to processor card 202. I/O connector 218 may also be operably connected to processor 204. In this embodiment, I/O connector 218 may be a J3 expansion card data connector with 80 I/O lines.

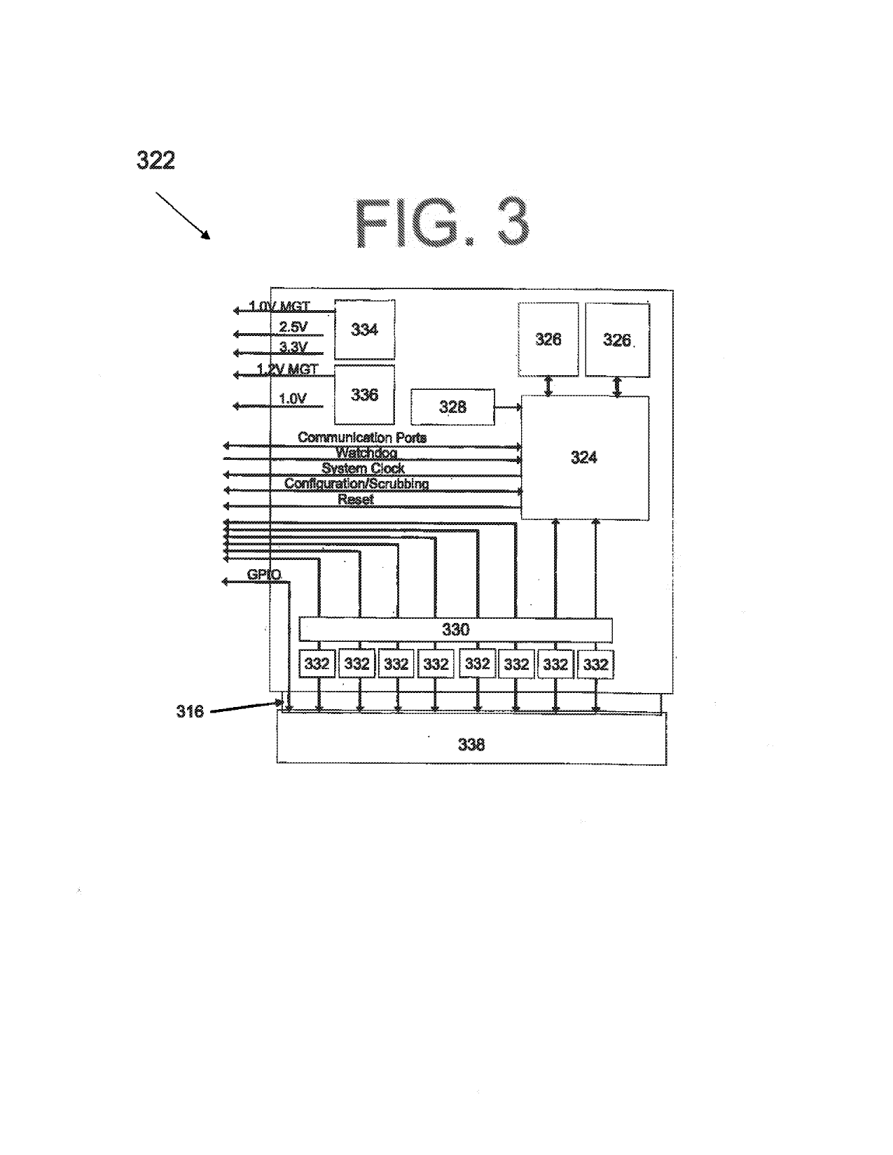

Processor 202 is configured to receive instructions from, or may be reprogrammed by, an FPGA module, such as FPGA module 324 depicted in FIG. 3. FIG. 3 illustrates a hybrid card 322. FPGA module 324 may be a non programmable FPGA module. Depending on design choice, FPGA module 324 may be an Aeroflex UT6325 FPGA module, for example.

In certain embodiments, FPGA module 324 may include computer program instructions for scrubbing, monitoring, or resetting the processor shown in FIG. 2. FPGA module 324 may be included on hybrid card 322, and retrieve programmable code stored on flash memory 326, such that FPGA module 324 may utilize the reprogrammable code to reprogram or reconfigure the processor. For example, flash memory 326 may store configuration files used to configure the processor, initial configuration data used to perform initial configuration on the processor, collected data from instruments, etc.

FPGA module 324 may be connected to a processor through a plurality of connection lines. For example, the plurality of connection lines may include a communication port connection line, a watchdog connection line, a system clock connection line, a configuration and scrubbing connection line, and a reset connection line.

Watchdog connection line may provide information pertaining to the status of the processor to FPGA module 324, and if watchdog communication line fails to provide information to FGPA module 324, then FPGA module 324 may detect an error and reset the processor through the reset communication line. In this embodiment, FPGA module 324 may configure or reconfigure the processor through the configuration and scrubbing communication line. For example, FPGA module 324 may rewrite (or scrub) the configuration in the processor to clear any upsets that may occur during flight operation. A general purpose I/O (GPIO) communication line may communicate data to and from the processor and an external device connected to I/O connector 338.

Hybrid card 322 may also include an oscillator 328. Oscillator 328 is configured to function as a system clock. Data pertaining to the system clock may be transmitted from FPGA module 324 to the processor.

Hybrid card 322 may also include a plurality of ports 332, each of which connect to I/O connector 338. I/O connector 338 may be a J2 hybrid card I/O connector having 80 single ended lines, and may allow connection to a bus of the spacecraft. Ports 332 may also be connected to transceivers 330. Transceivers 330 may be configured to create a buffer to protect ports 332 from being damaged by external sources.

Hybrid card 322 may also include at least two MGT point of load (POL) convertors 334, 336 to provide power to a processor, such as processor 204. MGT POL 334 may include 1.0 volt of power, and MGT POL 336 may include 1.2 volts of power in some embodiments.

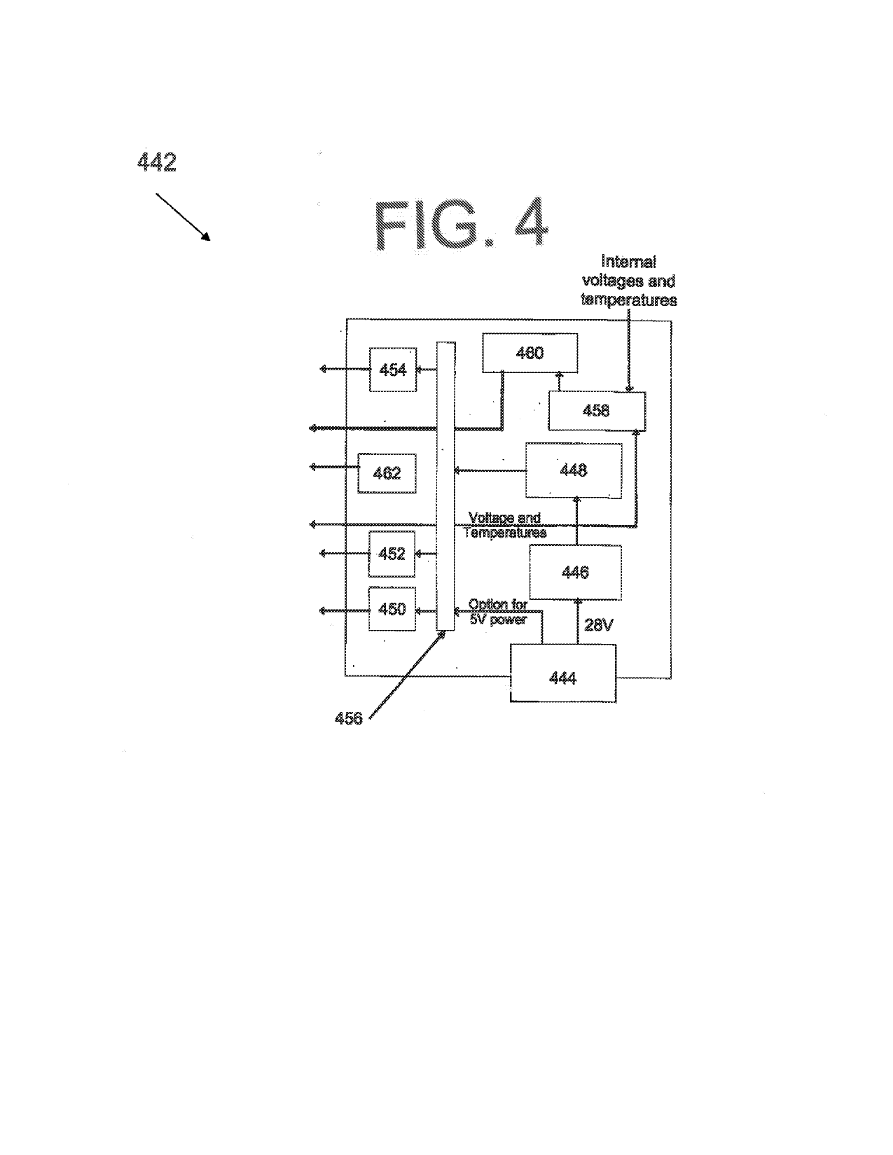

Connected to hybrid card 322 via a rigid flex connection (not shown) is a power card, such as that shown in FIG. 4. Power card 442 includes a power connector 444 that receives approximately 28 volts of power from a power supply (not shown). Power card 442 also includes an electromagnetic filter (EMI) filter 446 to suppress interference found in the power line, and a direct-current-to-direct-current (DC-DC) converter 448 to reduce a source voltage of approximately 28 volts to a lower voltage level of approximately 5 volts. A plurality of POL converters 450, 452, and 454 are configured to provide different voltages to various components on the hybrid card and the processor card. In this embodiment, the internal bus 456 receives power from either the DC-DC converter 448 or in a Cube Sat configuration, 5 volts of power from an external power supply (not shown). Bus 456 may be a 5 volt bus in this embodiment and be configured to down convert the voltages for various components, such that POL converter 450 includes 2.5 volts of power, 452 includes 1.0 volt of power and POL converter 454 includes approximately 3.3 volts of power.

Power card 442 also may include an analog multiplexer 458 that may receive voltage and temperature data of the space mini-cube and/or of the spacecraft. For example, analog multiplexer 458 may be configured to transmit the data to, and receive the data from, the spacecraft via the I/O connector show-n in FIG. 3. A/D converter 460 transmits the voltage and temperature data to the FPGA module. A reset circuit 462 may also be included on power card 442, such that the FPGA module can be instructed to reset the processor.

One or more embodiments of the present invention pertain to a space mini-cube that can be used as an on-board space processing system capable of more than 2500 MIPS, and weighs less than 3 pounds while utilizing less than 10 watts of power. The mini-cube includes a processor card and a hybrid card. The processor card includes a processor that can be programmed and reprogrammed prior to, and during, spaceflight. The hybrid card includes a field programmable gate array module that can program and reprogram the processor prior to, and during, the spaceflight.

One having ordinary skill in the art will readily understand that the invention as discussed above may be practiced with steps in a different order, and/or with hardware elements in configurations that are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A spacecraft processing apparatus, comprising:
a processor card comprising a processor configured to be programmable and reprogrammable prior to, and during, spaceflight; and
a hybrid card comprising a field programmable gate array module configured to program and reprogram the processor prior to, and during, the spaceflight.

2. The spacecraft processing apparatus of claim 1, wherein the spacecraft processing apparatus is approximately 3 inches by 3 inches by 3 inches to form a mini-cube.

3. The spacecraft processing apparatus of claim 1, wherein the field programmable gate array module is a radiation hardened field programmable gate array module configured to program and scrub the processor based on configuration files.

4. The spacecraft processing apparatus of claim 3, wherein the hybrid card comprises a flash memory configured to store the configuration files for the processor.

5. The spacecraft processing apparatus of claim 1, further comprising:
a plurality of rigid flex connections configured to connect the processor card, the hybrid card, and a power card.

6. The spacecraft processing apparatus of claim 1, wherein the processing card comprises at least two reprogrammable in-flight processors.

7. The spacecraft processing apparatus of claim 1, further comprising:
a power card configured to receive power from a power supply and provide power to the processor card and the hybrid card.

8. An on-board space processing system, comprising:
a processor card comprising a reprogrammable processor; and a hybrid card comprising a field programmable gate array module configured to program the reprogrammable processor at initialization of the system and reprogram the processor during flight.

9. The on-board space processing system of claim 8, wherein the system is configured to process data at more than 2500 Million Instructions Per Second.

10. The on-board space processing system of claim 8, wherein the system is approximately 3 inches by 3 inches by 3 inches to form a mini-cube.

11. The on-board space processing system of claim 8, wherein the system is configured to consume less than 10 watts of power.

12. The on-board space processing system of claim 8, wherein the system weighs less than 3 pounds.

13. The on-board space processing system of claim 8, wherein the hybrid card comprises flash memory comprising programmable instructions for the processor.

14. The on-board space processing system of claim 13, wherein the field programmable gate array module is configured to program or reprogram the processor based on the programmable instructions stored in the flash memory.

15. The apparatus, comprising:
a processor card operably coupled to a hybrid card via a first rigid flex connection; and
a power card operably coupled to the hybrid card via a second rigid flex connection, wherein
the processor card comprises a reprogrammable processor configured to process data at more than 2500 Million Instructions Per Second onboard a spacecraft.

16. The apparatus of claim 15, wherein the hybrid card comprises flash memory configured to store programmable instructions for the reprogrammable processor.

17. The apparatus of claim 16, wherein the hybrid card further comprises a field programmable gate array configured to execute the programmable instructions to program or reprogram the processor prior to, or during, a space mission.

18. The apparatus of claim 15, wherein the processor card comprises low voltage differential signal transceivers configured to create a buffer to protect the processor, or one or more ports connected to the processor, from being damaged.

19. The apparatus of claim 15, wherein the processor card comprises:
an input output connector operably connected to a scientific instrument; and
an expansion input output connector operably connected to a custom card.

20. The apparatus of claim 15, wherein the hybrid card comprises:
an input output connector configured to connect to a bus of a spacecraft; and
a plurality of transceivers coupled between one or more ports on the hybrid card, and the reprogrammable processor and between the one or more ports and a field programmable gate array module, wherein
the plurality of transceivers are configured to protect the one or more ports from being damaged.
